(19) United States
(12) Patent Application Publication
(10) Pub. No.: US 2001/0007993 A1
(43) Pub. Date: Jul. 12, 2001

(54) Electronic mail delivery method and system

(75) Inventor: E-Young Wu, Taipei (TW)

Correspondence Address: CHRISTENSEN, O'CONNOR,, JOHNSON & KINDNESS PLLC, 1420 Fifth Avenue, Suite 2800, Seattle, WA, 98101-2347, US

(73) Assignee: New Global On Line Corp.

(21) Appl. No.: 09/753,542

(22) Filed: Jan. 2, 2001

(30) Foreign Application Priority Data
Jan. 6, 2000 (TW) 089100163

(51) Int. Cl. G06F 15/16

(52) U.S. Cl. 709/207; 709/206; 709/227

(57) ABSTRACT

In an electronic mail delivery method, a sending computer is operated so as to create an electronic mail and to set parameters of the electronic mail, including address of an intended mail recipient. A connection is then established between the sending computer and a mail-handling server, and the electronic mail and the parameters thereof are transmitted from the sending computer to the mail-handling server. The mail-handling server stores the electronic mail received from the sending computer in a location thereof, and transmits a mail alert message, which includes location information of the electronic mail in the mail-handling server, to the sending computer. The sending computer forwards the mail alert message received from the mail-handling server to a receiving computer of the intended mail recipient. Upon receipt of the mail alert message, the receiving computer is operated to establish a connection with the mail-handling server, and to download the electronic mail from the mail-handling server.

### BACKGROUND OF THE INVENTION

1. Field of the Invention

The invention relates to mail delivery systems, more particularly to an electronic mail delivery method and system.

2. Description of the Related Art

The use of computers and the Internet for sending and receiving messages in electronic form has experienced an explosive growth in popularity over the past few years. When transmitting an electronic mail (hereinafter referred to as e-mail), the mail sender sends the e-mail, which includes the e-mail address of a mail recipient, to a mail server by establishing a network connection with the mail server through the use of his or her computer. The mail server then forwards the e-mail to a personal mailbox of the mail recipient.

It is noted that security in a conventional e-mail delivery method and system is inadequate since e-mails are susceptible to hacking during the course of transmission. Thus, e-mails are seldom used for conveying confidential messages. While coding schemes, such as SSL with a coding/decoding password length of 40 or 128 bits, and DES with a coding/decoding password length of 56 or 112 bits, are available in the art for encrypting e-mails to provide security during transmission, such coding schemes offer inadequate protection against skilled hackers. There is thus a need to further enhance security during transmission of e-mails.

Moreover, e-mails sometimes cannot be properly received in instances when the computer-operating platform of the sending side differs from that of the receiving side. Different computer-operating platforms are unavoidable due to natural language differences. For example, English-speaking places generally use an English-based computer-operating platform, while Chinese-speaking places generally use a Chinese-based computer-operating platform. It is desirable to ensure proper reception of e-mails regardless of the computer-operating platforms used by the sending and receiving sides.

Furthermore, notification of the transmission status of e-mails is generally not available. The sending party is usually unable to determine the transmission status of e-mails once the latter are sent. There is thus a need to inform the sending party when e-mails are lost during the course of transmission or are not properly received by the sending party in their entirety.

In addition, most mail servers only allocate 2 Mbytes of memory space for every personal mailbox. This can easily lead to transmission failure due to insufficient space especially when audio and video files are transmitted.

### SUMMARY OF THE INVENTION

Therefore, the object of the present invention is to provide an electronic mail delivery method and system capable of overcoming the aforesaid drawbacks that are commonly associated with the prior art.

According to one aspect of this invention, an electronic mail delivery method comprises the steps of:

(a) creating an electronic mail, and setting parameters of the electronic mail, including address of an intended mail recipient, via a sending computer;

(b) establishing a connection between the sending computer and a mail-handling server, and transmitting the electronic mail and the parameters thereof from the sending computer to the mail-handling server;

(c) storing the electronic mail received from the sending computer in a location of the mail-handling server, and enabling the mail-handling server to transmit a mail alert message, which includes location information of the electronic mail in the mail-handling server, to the sending computer;

(d) enabling the sending computer to forward the mail alert message received from the mail-handling server to a receiving computer of the intended mail recipient; and

(e) upon receipt of the mail alert message, operating the receiving computer to establish a connection with the mail-handling server, and to download the electronic mail from the mail-handling server.

According to another aspect of this invention, an electronic mail delivery system comprises a sending computer, a mail-handling server, and a receiving computer. The sending computer is adapted to be operated by a mail sender so as to create an electronic mail and to set parameters of the electronic mail, including address of an intended mail recipient. The sending computer is further operable so as to establish a connection with the mail-handling server and to transmit the electronic mail and the parameters thereof to the mail-handling server. The mail-handling server stores the electronic mail received from the sending computer in a location thereof, and transmits a mail alert message, which includes location information of the electronic mail in the mail-handling server, to the sending computer. The sending computer forwards the mail alert message received from the mail-handling server to the receiving computer, which is to be operated by the intended mail recipient. Upon receipt of the mail alert message, the receiving computer is operable so as to establish a connection with the mail-handling server, and to download the electronic mail from the mail-handling server.

### BRIEF DESCRIPTION OF THE DRAWINGS

Other features and advantages of the present invention will become apparent in the following detailed description of the preferred embodiment with reference to the accompanying drawings, of which:

FIG. 1 is a functional diagram of the preferred embodiment of an electronic mail delivery system according to the present invention;

FIG. 2 is a flowchart to illustrate the electronic mail delivery method of the preferred embodiment; and

FIG. 3 is a flow diagram illustrating how e-mails are handled in the preferred embodiment.

### DETAILED DESCRIPTION OF THE PREFERRED EMBODIMENT

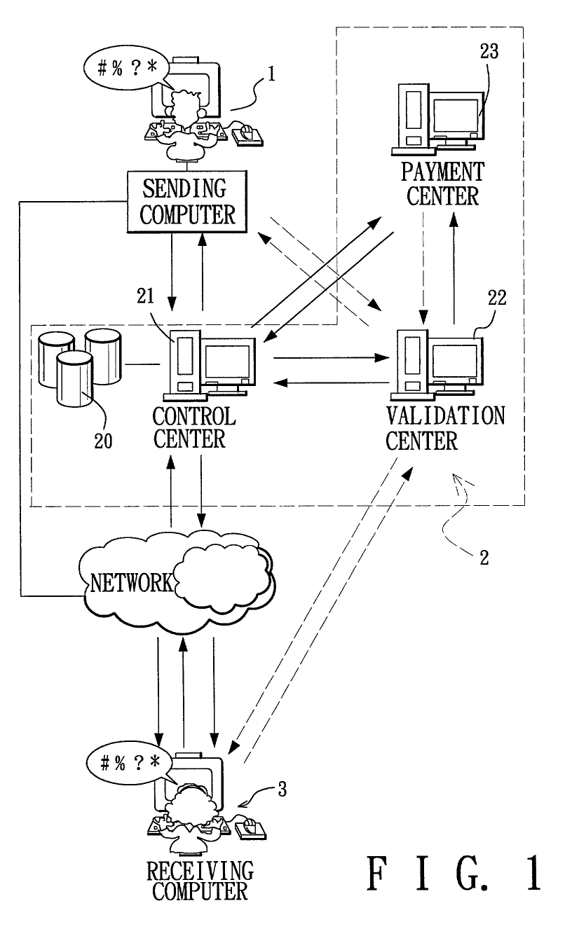

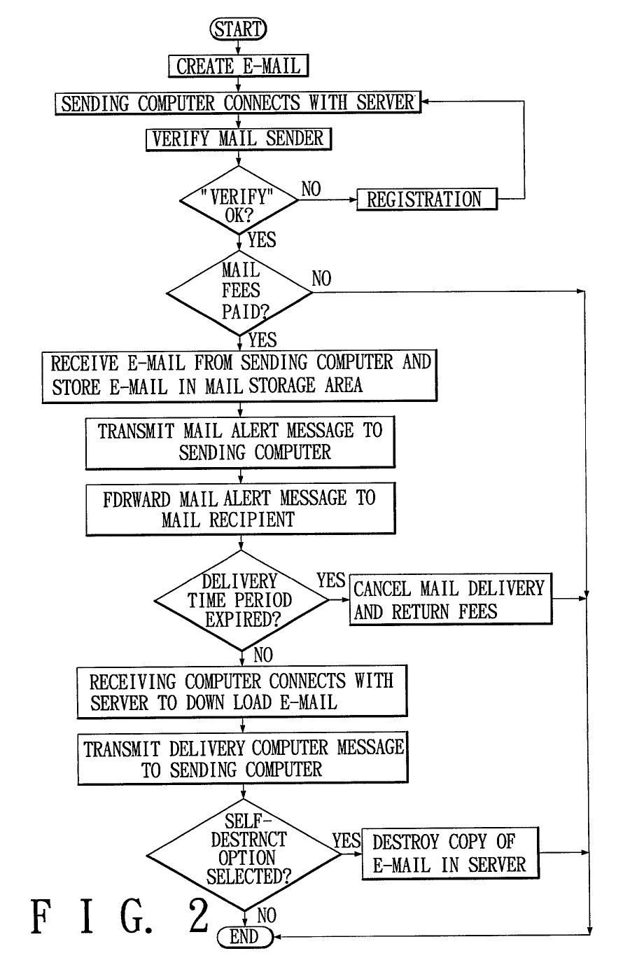

Referring to FIGS. 1 and 2, the present invention is embodied in an electronic mail (hereinafter referred to as e-mail) delivery system that acts as a virtual postal system and that includes a sending computer 1, a mail-handling server 2, and a receiving computer 3.

The sending computer 1 is adapted to be operated by the mail sender to create an e-mail and to set parameters for the e-mail, including address of the intended mail recipient, a delivery time period, and an optional self-destruct instruction. The sending computer 1 is also under the control of the mail sender for establishing a connection with the mail-handling server 2.

The mail-handling server 2, which serves as a virtual post office, may include a single server. However, in order to accommodate large amounts of information, the mail-handling server 2 may consist of a cluster of servers, e.g. a main mail-handling server and at least one auxiliary mail-handling server connected to the main mail-handling server. In the latter case, either of the main and auxiliary mail-handling servers can process e-mails from the sending computer 1. As such, when one of the main and auxiliary mail-handling servers breaks down, the remaining ones of the main and auxiliary mail-handling servers are available to handle the e-mail processing task, thereby resulting in a highly efficient and reliable system.

The mail-handling server 2 includes a control center 21, a mail storage area 20, a validation center 22 and a payment center 23. Upon connecting with the mail-handling server 2, the mail-handling server 2 performs a verification procedure to verify the mail sender. During verification, the mail-handling server 2 receives a user account number and a user password from the sending computer 1 to enable the mail-handling server 2 to verify the mail sender. If the mail-handling server 2 fails to verify the mail sender, the mail-handling server 2 guides the mail sender through a registration procedure to generate the user account number and the user password for the mail sender. After registration, the mail sender reconnects with the mail-handling server 2 to repeat the verification procedure.

The payment center 23 of the mail-handling server 2 is responsible for charging mail-handling fees from a monetary account of the mail sender before the mail-handling server 2 can process the e-mail to be transmitted by the sending computer 1. Charging by the payment center 23 can be conducted in several ways. For example, the mail sender can have a prepaid account in the mail-handling server 2, and the payment center 23 deducts the mail-handling fees from the prepaid account for every e-mail transaction. Alternatively, the payment center 23 can charge the mail-handling fees from a credit card or a bank account of the mail sender. Preferably, for the sake of security, the user account number and the user password of the mail sender are encrypted during transmission to the mail-handling server 2. Credit card and/or bank account information of the mail sender are likewise encrypted during each charging transaction.

Thus, after the mail-handling server 2 has successfully verified the mail sender, the payment center 23 charges the mail-handling fees from the monetary account of the mail sender. If the payment center 23 is unable to charge the mail-handling fees, e-mail processing by the delivery system of this invention is terminated.

Once the appropriate mail-handling fee has been charged by the payment center 23, the control center 21 of the mail-handling server 2 receives the e-mail and its parameters from the sending computer 1. Preferably, thee-mail and its relevant data are uploaded to the mail-handling server 2 in FTP or HTTP format. The control center 21 then stores the e-mail from the sending computer 1 in the mail storage area 20. Thereafter, the control center 21 transmits a mail alert message, which includes location information of the e-mail in the mail storage area 20, to the sending computer 1. Upon receipt of the mail alert message, the sending computer 1 forwards the same to the intended mail recipient without passing through the mail-handling server 2.

If the e-mail was not retrieved by the intended mail recipient after expiry of the delivery time period set by the mail sender, the mail-handling server 2 cancels delivery of the e-mail to the intended mail recipient, sends an undeliverable mail message to the mail sender, and returns the mail-handling fees collected thereby to the mail sender.

In the preferred embodiment, if the intended mail recipient does not promptly download the e-mail from the mail sender, the control center 21 can be configured to send periodic reminder messages to the intended mail recipient to ensure whether or not the mail alert message was received by the intended mail recipient.

The receiving computer 3 is under the control of the intended mail recipient. When the intended mail recipient receives the mail alert message from the sending computer 1 through the use of the receiving computer 3, the receiving computer 3 can be operated by the intended mail recipient to establish a connection with the mail-handling server 2 and to download the corresponding e-mail from the mail-handling server 2 in accordance with the location information that is contained in the mail alert message. In the preferred embodiment, the mail alert message is configured to automatically guide the receiving computer 3 to download the corresponding e-mail from the mail-handling server 2. The e-mail downloaded by the receiving computer 3 can be in the FTP format. Before the receiving computer 3 downloads the corresponding e-mail, the mail-handling server 2 can automatically append relevant data, such as batch number, date and time information, etc. to the e-mail.

If connection with the mail-handling server 2 was abruptly terminated during the course of transmission, the control center 21 can be configured to make a record of the cause of the transmission failure, and to inform the receiving computer 3 as to the location of the e-mail which has yet to be downloaded. This enables the receiving computer3 to reconnect with the mail-handling server 2 for downloading the e-mail.

In the preferred embodiment, upon detection that the receiving computer 3 has successfully browsed or downloaded the corresponding e-mail, the control center 21 of the mail-handling server 2 can be configured to automatically send a delivery complete message to the sending computer 1 and to make a record of the download transaction for future reference by the mail sender.

Generally, after the e-mail has been successfully downloaded from the mail-handling server 2, a copy of the e-mail remains in the mail-handling server 2 for a period of time. However, if the self-destruct instruction was selected by the mail sender, the mail-handling server 2 automatically destroys the copy of the e-mail stored therein immediately after the receiving computer 3 has successfully downloaded the e-mail.

It is evident from the foregoing that the control center 21 can make a record of the status of the e-mails stored therein, such as whether the e-mails have been browsed by their intended mail recipients, whether the e-mails have been downloaded, etc. Preferably, if the intended mail recipient wishes to cancel a mail transaction, he can inform the control center 21 for canceling the transmission of a particular e-mail.

The mail-handling server 2 includes the validation center 22 for issuing validation proofs to the mail sender and the intended mail recipient so as to enhance security of e-mail transmissions. The validation center 22 allows the user to download key generating software for generating DES/RSA keys. Upon using the software, a pair of 1024 or 2048-bit RSA keys are generated. One of the keys is a private key that is under the responsibility of the user. The other key is a public key that is sent to the validation center 22, together with a request for a validation proof. After validation, the validation center 22 issues a validation proof that complies with the X.509 standard. A document encrypted through the use of a validation proof can only be deciphered with the use of a private key of the intended mail recipient. In addition, a document signed with the private key of the mail sender can be verified by the mail recipient through the validation proof that was issued by the validation center 22.

Thus, when a non-validated mail sender wishes to send an encrypted e-mail, the mail sender has to make a request for validation with the validation center 22. Upon receipt of the validation proof, the mail sender can check if the intended mail recipient has been validated. If the intended mail recipient has yet to be validated, the mail sender can issue a request for validating the intended mail recipient. Upon receiving the request for validating the intended mail recipient, the validation center 22 sends the appropriate key generating software to the mail recipient. The mail recipient executes the key generating software, and the resulting public key is sent to the validation center 22 to enable the latter to issue the X.509 standard-compliant validation proof for the mail recipient that is sent to both the mail sender and the mail recipient. The mail sender uses his private key and the validation proof of the intended mail recipient to encrypt the e-mail. The mail recipient can use his private key to decipher the e-mail, and can verify the signature on the e-mail with the use of the validation proof of the mail sender, which can be availed from the validation center 22.

As such, when an encrypted e-mail is intercepted during the course of transmission, the e-mail cannot be deciphered without the private key of the intended mail recipient, thereby resulting in enhanced security. In addition, due to the inclusion of the signature verification capability, the mail recipient can tell whether or not the e-mail was actually sent by the listed mail sender.

There are two methods available in the delivery system of this invention to allow the mail sender and the intended mail recipient to send and receive e-mails using different computer-operating platforms. In the first method, the mail-handling server 2 provides portable document translator software, such as DynaDoc or Acrobat, to the sending and receiving computers 1, 3. The sending computer 1 is thus operable to translate the e-mail into a portable format prior to transmission to the mail-handling server 2, and the receiving computer 3 is operable to translate the portable document downloaded from the mail-handling server 2 back into the original format for viewing regardless of the operating platforms of the sending and receiving computers 1, 3. In the second method, the mail-handling server 2 determines the operating platform used by the sending computer 1 to create the e-mail, detects whether the same operating platform is resident in the receiving computer 3, and allows the receiving computer 3 to download the operating platform when the latter is not resident in the receiving computer 3, thereby allowing the mail recipient to properly view the e-mail. Of course, it is also possible for the mail recipient to browse the e-mail in an acceptable format directly from the mail-handling server 2 without downloading the same.

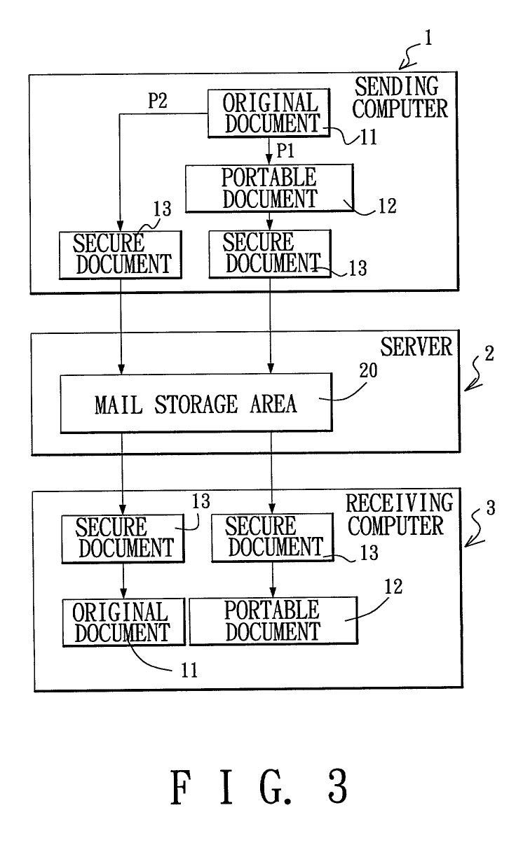

FIG. 3 is a flow diagram illustrating how e-mails are handled according to the preferred embodiment. Via the sending computer 1, the mail sender creates an original document 11 using known word-processing software, such as Word or Notepad. Thereafter, two options (P1, P2) are available for selection by the mail sender. In the first option, the original document 11 is translated into a portable document 12 using the portable document translator software. The portable document 12 is encrypted thereafter in the manner described above to result in a secure document 13. In the second option, the original document 11 is encrypted without portable document translation to result in a secure document 13. The mail sender then makes a request to connect with the mail-handling server 2. Upon connecting with the mail-handling server 2, the mail sender is verified by the mail-handling server 2. After the mail sender has been successfully verified, and after the payment center 23 has successfully charged the appropriate mail-handling fees, the mail-handling server 2 receives the secure document 13 from the sending computer 1 and stores the same in the mail storage area 20. The mail-handling server 2 sends the mail alert message to the sending computer 1, which includes the location of the secure document 13 in the mail storage area 20, and the sending computer 1 responds by forwarding the mail alert message to the intended mail recipient without passing through the mail-handling server 2.

Upon receiving the mail alert message from the sending computer 1, the mail recipient uses the receiving computer 3 to establish a connection with the mail-handling server 2 to download the corresponding e-mail. If the corresponding e-mail is in a portable document format, the mail-handling server 2 inspects whether the receiving computer 3 is equipped with the required portable document translator software. If the receiving computer 3 lacks the portable document translation facility, the mail-handling server 2 guides the mail recipient to download not only the corresponding e-mail from the mail storage area 20 but also the required portable document translator software with the use of the receiving computer 3. The secure document 13 can be deciphered by the mail recipient in the manner described beforehand to obtain the portable document 12 that can be viewed with the use of the portable document translator software. If the corresponding e-mail is not in the portable document format, the mail-handling server 2 inspects the operating platform used to create the original document 11, detects whether the same operating platform is resident in the receiving computer 3, and allows the mail recipient to download not only the corresponding e-mail from the mail storage area 20 but also the required operating platform with the use of the receiving computer 3. The secure document 13 can be deciphered by the mail recipient in the manner described beforehand to obtain the original document 11 that can be viewed with the use of the downloaded operating platform. As mentioned beforehand, it is also possible for the mail recipient to browse the e-mail in an acceptable format directly from the mail-handling server 2 upon encryption without downloading the same.

It is noted that, because users are not allocated with a personal mailbox in the delivery system of this invention, there are no limits to the size of the e-mails that can be sent by the mail sender and received by the mail recipient. In addition, because the sending computer 1 is responsible for informing the intended mail recipient of the need to retrieve the e-mail from the mail-handling server 2, the load of the mail-handling server 2 can be reduced. This is more evident when the same e-mail is to be sent to more than one mail recipient.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An electronic mail delivery method, comprising the steps of:
(a) creating an electronic mail, and setting parameters of the electronic mail, including address of an intended mail recipient, via a sending computer;
(b) establishing a connection between the sending computer and a mail-handling server, and transmitting the electronic mail and the parameters thereof from the sending computer to the mail-handling server;
(c) storing the electronic mail received from the sending computer in a location of the mail-handling server, and enabling the mail-handling server to transmit a mail alert message, which includes location information of the electronic mail in the mail-handling server, to the sending computer;
(d) enabling the sending computer to forward the mail alert message received from the mail-handling server to a receiving computer of the intended mail recipient; and
(e) upon receipt of the mail alert message, operating the receiving computer to establish a connection with the mail-handling server, and to download the electronic mail from the mail-handling server.

2. The electronic mail delivery method of claim 1, further comprising the step of:
(f) enabling the mail-handling server to transmit a delivery complete message to the sending computer upon detection that the receiving computer has downloaded the electronic mail.

3. The electronic mail delivery method of claim 1, wherein the parameters of the electronic mail set in step (a) further include a delivery time period, the method further comprising the step of:
(g) enabling the mail-handling server to cancel delivery of the electronic mail to the intended mail recipient upon detection that the electronic mail has yet to be downloaded by the intended mail recipient after expiry of the delivery time period.

4. The electronic mail delivery method of claim 1, wherein the parameters of the electronic mail set in step (a) further include an optional self-destruct instruction, the method further comprising the step of:
(h) immediately after the receiving computer has downloaded the electronic mail, enabling the mail-handling server to destroy a copy of the electronic mail stored therein upon detection that the self-destruct instruction was selected.

5. The electronic mail delivery method of claim 1, further comprising the step of:
(b-1) prior to transmitting the electronic mail from the sending computer to the mail-handling server, enabling the mail-handling server to verify user of the sending computer.

6. The electronic mail delivery method of claim 5, wherein, in step (b-1), the mail-handling server receives an account number and a password from the sending computer to enable the mail-handling server to verify the user of the sending computer.

7. The electronic mail delivery method of claim 6, wherein, in step (b-1), the mail-handling server guides the user of the sending computer through a registration procedure to generate the account number and the password for the user of the sending computer when the mail-handling server has failed to verify the user of the sending computer.

8. The electronic mail delivery method of claim 1, further comprising the step of:
(b-2) prior to transmitting the electronic mail from the sending computer to the mail-handling server, operating the sending computer to encrypt the electronic mail using a validation proof obtained from the mail-handling server and issued by the mail-handling server to the intended mail recipient.

9. The electronic mail delivery method of claim 8, wherein, in step (b-2), upon detection by the user of the sending computer that the intended mail recipient has yet to be issued with the validation proof,
operating the sending computer to issue a request to the mail-handling server for validating the intended mail recipient,
enabling the mail-handling server to send validating software to the receiving computer of the intended mail recipient, and
enabling the receiving computer to send a public key, which is generated upon execution of the validating software, to the mail-handling server, thereby allowing the mail-handling server to generate the validation proof for the intended mail recipient that is subsequently transmitted to the sending computer.

10. The electronic mail delivery method of claim 1, further comprising the step of:
(b-3) prior to transmitting the electronic mail from the sending computer to the mail-handling server, enabling the mail-handling server to charge mail handling fees from a monetary account of the user of the sending computer.

11. The electronic mail delivery method of claim 1, wherein, in step (e), prior to enabling the receiving computer to download the electronic mail from the mail-handling server, the mail-handling server determines an operating platform used by the sending computer to create the electronic mail, detects whether the operating platform is resident in the receiving computer, and allows the receiving computer to download the operating platform when the operating platform is not resident in the receiving computer.

12. An electronic mail delivery system, comprising:
a sending computer adapted to be operated by a mail sender so as to create an electronic mail and to set parameters of the electronic mail, including address of an intended mail recipient;
a mail-handling server, wherein the sending computer is further operable so as to establish a connection with the mail-handling server and to transmit the electronic mail and the parameters thereof to the mail-handling server;
wherein the mail-handling server stores the electronic mail received from the sending computer in a location thereof, and transmits a mail alert message, which includes location information of the electronic mail in the mail-handling server, to the sending computer; and
a receiving computer adapted to be operated by the intended mail recipient, wherein the sending computer forwards the mail alert message received from the mail-handling server to the receiving computer;
wherein, upon receipt of the mail alert message, the receiving computer is operable so as to establish a connection with the mail-handling server, and to download the electronic mail from the mail-handling server.

13. The electronic mail delivery system of claim 12, wherein the mail-handling server transmits a delivery complete message to the sending computer upon detection that the receiving computer has downloaded the electronic mail.

14. The electronic mail delivery system of claim 12, wherein the parameters of the electronic mail set by the sending computer further include a delivery time period, and wherein the mail-handling server cancels delivery of the electronic mail to the intended mail recipient upon detection that the electronic mail has yet to be downloaded by the receiving computer after expiry of the delivery time period.

15. The electronic mail delivery system of claim 12, wherein the parameters of the electronic mail set by the sending computer further include an optional self-destruct instruction, and
wherein, immediately after the receiving computer has downloaded the electronic mail, the mail-handling server destroys a copy of the electronic mail stored therein upon detection that the self-destruct instruction was selected.

16. The electronic mail delivery system of claim 12, wherein the mail-handling server verifies the mail sender prior to enabling transmission of the electronic mail from the sending computer to the mail-handling server.

17. The electronic mail delivery system of claim 16, wherein the mail-handling server receives an account number and a password from the sending computer to enable the mail-handling server to verify the mail sender.

18. The electronic mail delivery system of claim 17, wherein the mail-handling server guides the mail sender through a registration procedure via the sending computer to generate the account number and the password for the mail sender when the mail-handling server has failed to verify the mail sender.

19. The electronic mail delivery system of claim 12, wherein the sending computer is operable so as to encrypt the electronic mail using a validation proof obtained from the mail-handling server and issued by the mail-handling server to the intended mail recipient prior to transmitting the electronic mail from the sending computer to the mail-handling server.

20. The electronic mail delivery system of claim 12, wherein the mail-handling server is configured to charge mail handling fees from a monetary account of the mail sender prior to enabling transmission of the electronic mail from the sending computer to the mail-handling server.
